(19) United States
(12) Patent Application Publication
(10) Pub. No.: US 2003/0078806 A1
(43) Pub. Date: Apr. 24, 2003

(54) Teledentistry consult management system and method

(76) Inventors: Val L. Kudryk, Ashburn, VA (US); Mitra A. Rocca, Frederick, MD (US); John C. Pajak, Baltimore, MD (US)

Correspondence Address: OFFICE OF THE STAFF JUDGE ADVOCATE, U.S. ARMY MEDICAL RESEARCH AND MATERIEL COMMAND, ATTN: MCMR-JA (MS. ELIZABETH ARWINE), 504 SCOTT STREET, FORT DETRICK, MD, 21702-5012, US

(21) Appl. No.: 10/159,984

(22) Filed: Jun. 3, 2002

Related U.S. Application Data
(60) Provisional application No. 60/294,607, filed on Jun. 1, 2001.

(51) Int. Cl. G06F 17/60

(52) U.S. Cl. 705/2

(57) ABSTRACT

The invention provides a store and forward type electronic consult record with sufficient information for a dental specialist or consulting provider to render a diagnosis and to electronically submit that diagnosis back to the referring provider either in real time or at a later time. Accordingly, the invention provides a series of user interfaces or templates for collecting data from the referring provider relating to the patient and the patient's condition. The information is then assembled into a dental consult record that may be stored and/or transmitted to a remote computer where it may be accessed by a consulting provider. The consulting provider may access the dental consult record at any time, review the record, add a diagnosis and/or treatment recommendation to the record, store the record and electronically transmit the record back to the referring provider. The referring provider may then administer treatment to the patient as recommended.

This application claims priority from provisional application serial No. 60/294,607 filed Jun. 1, 2001 which is herein incorporated by reference.

### BACKGROUND OF THE INVENTION

1. Field of the Invention

The invention relates generally to the field of telemedicine and, more particularly, to systems, methods and articles of manufacture for facilitating consultation/communication between referring and consulting providers in the field of dentistry.

2. Description of the Related Art

Telemedicine has been defined as the use of information technology to deliver medical services and information from one location to another as a substitute for face-to-face contact between provider and client, so that provider and client do not have to be in the same place at the same time. Teledentistry is the practice of dentistry using communication technology to carry information between two or more points.

Video teleconferencing systems have been used for medical consultations for some time. Such systems may employ POTS (plain old telephone systems) and/or ISDN (integrated services digital network) networks as means for electronic data communication. For example, the U.S. Army experimented with a dentistry system comprising a desktop computer having a 28.8 k modem and employing ShareVision PCS 3000 software and a digital camera to transmit images from one U.S. Army installation to a second U.S. Army installation. This system proved to be expensive in terms of the cost of equipment and maintenance. In addition, the system exhibited technical drawbacks, e.g., the participants on both ends of the communication (the referring and consulting providers) must employ the same POTS-based system. Other drawbacks include the fact that the examination of the patient must be performed in real time and that the referring provider cannot append any additional information to the images transmitted by the system to help the consulting provider make a diagnosis or prescribe treatment.

Traditionally, patients requiring dental specialty treatment are required to travel to the specialist's office for evaluation. The specialist examines the patient and then treatment options are given. After treatment by the specialist, there is often a need for the patient to return for several follow up visits for re-evaluation. Often, the visits take only a few minutes of actual appointment time but require hours of travel by the patient. In some instances, patients will not bother with these appointments due to inconvenience or economics, thus potentially delaying treatment or forgoing treatment all together, which may result in major dental problems in the future. Accordingly, there is a need for a technology that will reduce unnecessary patient travel by facilitating patient examination, diagnosis and treatment by remotely located specialists.

### SUMMARY OF THE INVENTION

It is an object of the invention to provide a system that assists a referring provider in treating patients, where the referring provider is unfamiliar with the patients' specific condition or ailment.

It is another object of the invention to provide a system that permits patients who are separated from dental specialists to receive expert level care without having to travel to the specialist.

These and other objects may be realized by a system and method in accordance with the invention that provides a store and forward type electronic consult record with sufficient information for a dental specialist or consulting provider to render a diagnosis and to electronically submit that diagnosis back to the referring provider either in real time or at a later time. The system provides a series of user interfaces or templates for collecting data from the referring provider relating to the patient and the patient's condition. The information is then assembled into a dental consult record that may be stored and/or transmitted to a remote computer where it may be accessed by a consulting provider. The consulting provider may access the dental consult record at any time, review the record, add a diagnosis and/or treatment recommendation to the record, store the record and electronically transmit the record back to the referring provider. The referring provider may then administer treatment to the patient as recommended. In addition, because the dental consult is archived in a storage medium, it may be accessed at any time for teaching or other purposes.

### BRIEF DESCRIPTION OF THE DRAWINGS

FIG. 1 is a diagram showing a computer system in accordance with the invention.

FIG. 2 is a diagram illustrating an exemplary network according to the present invention.

FIG. 3 is a flowchart depicting a process for generating a consult request.

FIG. 4 is a user interface in accordance with the present invention.

FIG. 5 is another user interface in accordance with the present invention.

FIG. 6 is still another user interface in accordance with the present invention.

FIG. 7 depicts a consult record in accordance with an embodiment of the present invention.

FIG. 8 is a flowchart showing a process for answering a dental consult in accordance with an embodiment of the present invention.

FIG. 9 is a user interface in accordance with the present invention.

FIG. 10 is another user interface in accordance with the present invention.

### DETAILED DESCRIPTION OF THE INVENTION

The present invention is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. The accompanying drawings show preferred embodiments of the invention. Like reference numbers refer to like elements throughout.

As will be appreciated by one of skill in the art, the present invention may be embodied as a computer implemented method, a programmed computer, a data processing system, a signal, and/or computer program. Accordingly, the present invention may take the form of an entirely hardware embodiment, an entirely software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, or other storage devices.

Computer program code for carrying out operations of the present invention is preferably written in a plurality of languages including ASP (Active Server Pages), HTML (Hypertext Markup Language), SQL (Structured Query Language), and C++. However, consistent with the invention, the computer program code for carrying out operations of the present invention may also be written in other conventional procedural programming languages. The program code may execute entirely on the user's computer, as a stand-alone software package, or it may execute partly on the user's computer and partly on a remote computer. In the latter scenario, the remote computer may be connected directly to the user's computer via a LAN or a WAN (Intranet), or the connection may be made indirectly through an external computer (for example, through the Internet).

The present invention is described below with reference to flowchart illustrations of methods, apparatus (systems) and computer programs in accordance with the several embodiments of the invention. It will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means or program code that implements the function specified in the flowchart block or blocks.

The computer program instructions may also be loaded, e.g., transmitted via a carrier wave, to a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In general, the present invention defines a dental consult management system and method. The invention provides a store and forward type electronic consult record with sufficient information for a dental specialist or consulting provider to render a diagnosis and suggested treatment, to store the diagnosis and suggested treatment in the patient's electronic record and to electronically submit that diagnosis and suggested treatment back to the referring provider either in real time or at a later time. To that end the invention provides a series of user interfaces or templates for collecting data from referring provider relating to the patient and the patient's condition. The information is then assembled into a dental consult record that may be stored and/or transmitted to a remote computer where a consulting provider may access it. The consulting provider may access the dental consult record at any time, review the record, add a diagnosis and/or treatment recommendation to the record, store the record and electronically transmit the record back to the referring provider. The referring provider may then administer treatment to the patient as recommended.

### HARDWARE AND SOFTWARE FOR IMPLEMENTING THE PRESENT INVENTION

Various templates according to the present invention may be stored locally on a provider's stand-alone computer terminal, such as a desktop computer, laptop computer, palmtop computer, or personal digital assistant (PDA) or the like. Exemplary stand-alone computers may include, but are not limited to, Apple®, Sun Microsystems®, IBM®, or IBM®-compatible personal computers. Accordingly, the present invention may be carried out via a single computer system, such as a desktop computer or laptop computer.

According to a preferred embodiment, the templates may be centrally stored within one or more computers accessible to multiple users. Accordingly, users may access the templates through a private or public computer network in a conventional manner via wired or wireless communications. By maintaining the templates in a central location, updates can be easily made to the templates by a system administrator without having to access all of the machines in the network.

The present invention is preferably practiced within a “client/server” programming environment. As is known by those skilled in this art, client/server is a model for a relationship between two computer programs in which one program, the client, makes a service request from another program, the server, which fulfills the request. Although the client/server model can be used by programs within a single computer, it is more commonly used in a network where computing functions and data can more efficiently be distributed among many client and server programs at different network locations.

Many medical software applications use the client/server model. Typically, multiple client programs share the services of a common server program. Both client programs and server programs are often part of a larger program or application. Relative to the Internet, a Web browser is a client program that requests services (the sending of Web pages or files) from a Web server (which may be referred to as a Hypertext Transport Protocol or HTTP server) typically resident on another computer connected to Internet. Similarly, a computer with TCP/IP protocol installed allows client requests for files from File Transfer Protocol (FTP) servers in other computers on the Internet.

As is known to those with skill in this art, client/server environments may include public networks, such as the Internet, and private networks often referred to as “Intranets” and “Extranets.” The term “Internet” shall incorporate the terms “Intranet” and “Extranet” and any references to accessing the Internet shall be understood to mean accessing an Intranet and/or an Extranet, as well unless otherwise noted. The term “computer network” shall incorporate publicly accessible computer networks and private computer networks.

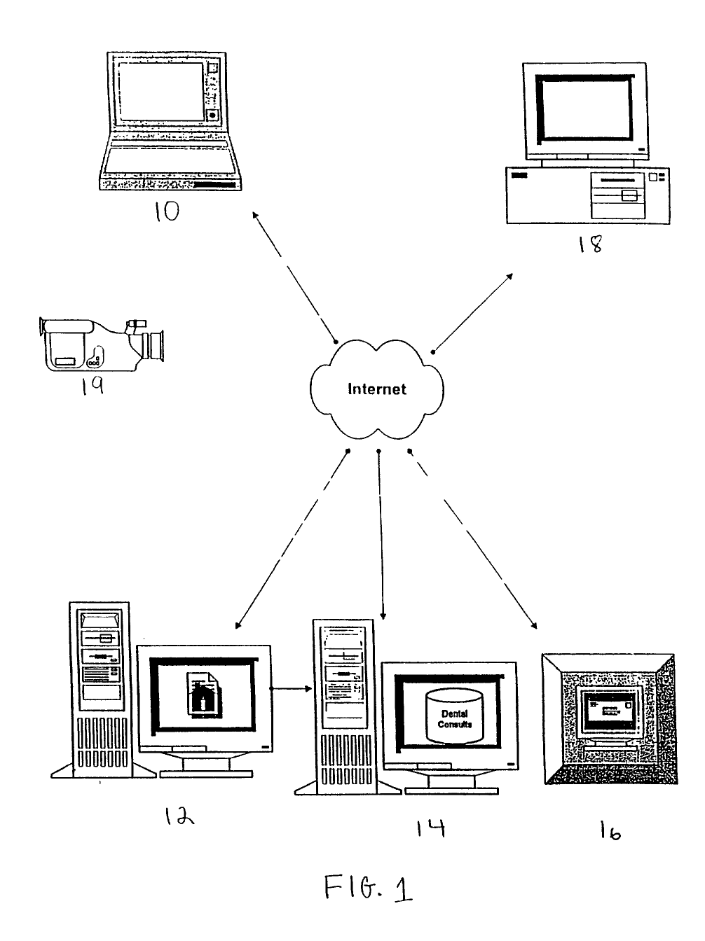

FIG. 1 illustrates a system in accordance with the present invention. The system includes a referring provider workstation 10, preferably provided with a web browser. The referring provider workstation 10 is in communication with at least one of a web server 12, a database server 14 and an email server 16 via a communications network. One or more of the database server 14, the web server 12 and the email server 16 may reside on the same machine. In keeping with the invention, one or more of the database server 14, the web server 12 and the email server 16 may also reside on separate machines. The web server 12 preferably stores dental consultation form templates according to the present invention while the database server 14 preferably stores the data corresponding to those templates.

A consulting provider workstation 18 is preferably provided in communication with the referring provider workstation 10 and at least one of the web server 12, a database server 14 and an email server 16 via a communications network, e.g., the Internet.

In operation, upon request of the referring provider, the referring provider workstation may retrieve a dental consultation template and the referring provider may input data to the template to create the dental consultation record. Using a digital imaging device, e.g., a digital camera 19, the referring provider may make images of the patient's mouth/teeth and link the images to the dental consultation record by uploading those images to the referring provider's workstation from conventional sources, such as PCMCIA storage cards, and floppy disks. The dental consultation data may be stored in a database and the consulting provider notified, preferably by email, that there is a request for consult pending.

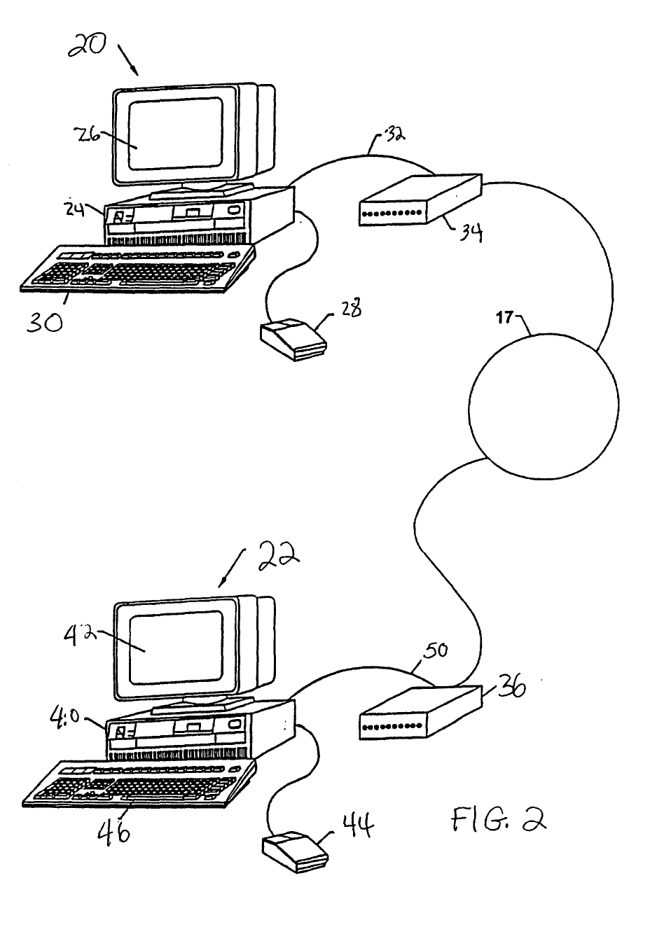

When responding to request for consult, the consulting provider may retrieve the dental consult record, review the data contained therein and input a diagnosis and/or recommended treatment for the patient to the dental consult record. Thereafter, the patient's dental consult record may be viewed, by those with access to web server 12 and database server 14. Preferably, access to web server 12 and database server 14 is limited to the referring provider and the consulting provider. However, to the extent permitted by law, access may be expanded to include, e.g., dental students, insurance company personnel, and others. FIG. 2 illustrates a client/server computing system in which the present invention may be embodied. In the illustrated system, remote user's computer 20 has a client application resident thereon, e.g., a web browser, and a host computer 22 having a server application resident thereon, e.g., one or more of web server 12, a database server 14 and an email server 16. As used herein, the term “remote user” refers to users who are separated from the web server. Therefore, the term “remote user” may refer to both the referring provider's workstation 10 and the consulting provider's workstation 18. The remote user's computer 20 preferably includes a central processing unit 24, a display 26, a pointing device 28, a keyboard 30, access to persistent data storage, and a communications link 32 for communicating with the host computer 22. The keyboard 30, having a plurality of keys thereon, is preferably in communication with the central processing unit 24. A pointing device 28, such as a mouse, is also connected to the central processing unit24. The communications link 32 may be established via a modem 34 connected to traditional phone lines, via DSL lines, an ISDN link, a T1 link, a T3 link, via cable modem, via an ethernet network, or the like. Modem 34 may also be a wireless modem configured to communicate with modem 36 of the host computer 22 via a wireless communications system. The communications link 32 also may be made by a direct connection of the remote user's computer 20 to the host computer 22 or indirectly via a computer network, such as the Internet, in communication with the host computer 22.

The central processing unit 24 contains one or more microprocessors (not shown) or other computational devices and random access memory (not shown) or its functional equivalent, including but not limited to, RAM, FLASHRAM, and/or VRAM for storing programs therein for processing by the microprocessor(s) or other computational devices. A portion of the random access memory and/or persistent data storage, referred to as “cache,” is often utilized during communications between remote user's computer 20 and a host computer 22 to store various data transferred from host computer 22.

Preferably, remote user's computer 20 has an Intel® Pentium® processor (or equivalent) with at least thirty-two megabytes (64 MB) of RAM, more preferably 128 MB of RAM or greater, and at least five megabytes (5 MB) of persistent computer storage 38 for caching. However, it is to be understood that various processors may be utilized to carry out the present invention without being limited to those enumerated herein. Although a color display is preferable, a black and white display or standard broadcast or cable television monitor may be used. It is further preferred that the remote user's computer 20 be provided with a client application in the form of a browser such as Netscape Navigator® or Internet Explorer®. Exemplary user computers having a client application resident thereon may include, but are not limited to, an Apple®, Sun Microsystems®, IBM®, or IBM®-compatible personal computer. Remote user's computer 20, if an IBM®, or IBM®-compatible personal computer, preferably utilizes either a Windows® 3.1, Windows 95®, Windows 98®, Windows NT®, Unix®, Windows 2000 or OS/2® operating system. However, other operating systems may also be utilized without limitation. In addition, it is to be understood that a terminal not having computational capability, such as an IBM® 3270 terminal or a network computer (NC), or having limited computational capability, such as a network PC (Net PC) may be utilized in accordance with the present invention for accessing a host computer 20 in a client capacity.

A host computer 22 may have a configuration similar to that of remote user's computer 20 and may include a central processing unit 40, a display 42, a pointing device 44, a keyboard 46, data storage 48, and a communications link 50 for connecting to remote computer 20 via a modem 36, or otherwise. It is preferable that a host computer 22 have an Intel® Pentium® processor or equivalent, at least thirty-two megabytes (64 MB) of RAM, more preferably 128 MB of RAM or greater, and at least two storage devices, one for data and the other for systems and application software. The storage device for data preferably has at least 20 Gigabytes of storage and the data storage device for systems and application software preferably includes at least 4 Gigabytes of storage. Hard drives are particularly preferred storage devices. However, other storage devices with the required capacity such as optical and tape devices are suitable for backup. Host computer 22 also may be implemented using other processors and via other computing devices, including, but not limited to, mainframe computing systems and mini-computers.

Host computer 22 preferably is provided with a web server and a database. A preferred web server is Microsoft's Internet Information Server (IIS) 4.0 or higher and a preferred database is Microsoft's SQL Server 7.0 or higher. The various templates that comprise the invention may be created using any known web page creation tool such as Macromedia Dreamweaver. The templates may be linked to the database using an interface program such as ASP (Active Server Pages).

It is understood that remote computer 20 having a client application resident thereon or host computer 22 having a server application resident thereon or other apparatus configured to execute program code embodied within computer usable media, may operate as means for performing the various functions and carry out the various operations of the present invention.

The system of FIG. 2 may be part of a telemedicine system wherein a referring provider workstation may be in communication with and remote from a server system. Likewise, a consulting provider workstation may be in communication with and remote from the referring provider workstation and the server system.

In accordance with method aspects of the present invention, a referring provider may build a dental consult record and transmit that record to a consulting provider where the consulting provider may provide a diagnosis and recommended treatment for the patient and transmit same back to a central treatment repository and/or to the referring provider. For example, a referring provider located in Landstuhl, Germany may examine a patient and require the assistance of a consulting provider who is resident in Washington D.C. The present invention allows the Landstuhl, Germany provider to prepare a dental consult record with the information necessary for the consulting provider to make a diagnosis and suggest a treatment. The dental consult record may be transmitted over a computer network so the consulting provider has almost instant access to the dental consult record. The consulting provider in Washington D.C. can make her diagnosis and recommendations for treatment and transmit them back to the referring provider in Landstuhl, Germany. All of this may be done while the patient is still in the referring provider's office within a matter of moments. The patient may then be treated and dismissed. In addition, the dental consult records may be stored in a central repository for later review.

Creating a Dental Consult Record

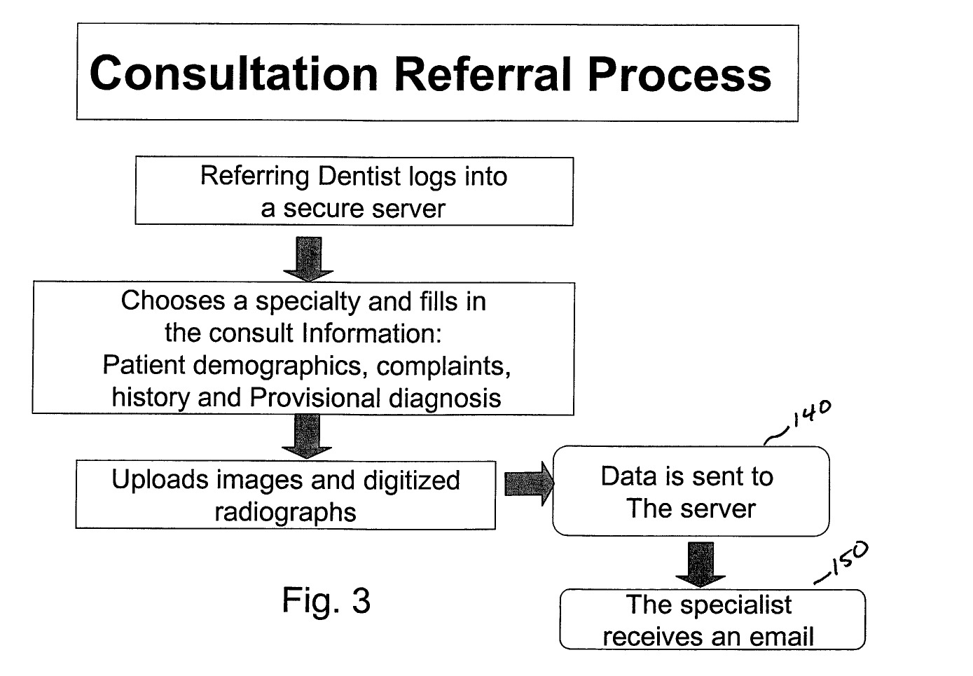

FIG. 3 illustrates a flow chart for an exemplary method of generating a consult request according to the present invention. A referring dentist is prompted to log into a secure server using a digital secure server ID, e.g., web server 12, preferably via referring provider workstation 10. Step 100. Upon log in, a dental consult template is preferably retrieved by referring provider workstation 10. The referring provider may then be prompted to choose a specialty from the dental consult template. Step 110. In step 120 the referring provider may be prompted to input consult data to the dental consult template, such as, one or more of patient demographics, complaints, history and a provisional diagnosis. The referring provider may then be prompted to upload images and/or digitized radiographs to the dental consult template to create a dental consult record. Step 130 Responsive to a command by the referring provider, the referring provider workstation then sends the data to the web server 12. Step 140. Optionally, a message may be sent to the consulting provider, e.g., an e-mail, informing the consulting providers of the existence of the pending request for consult. Step 150

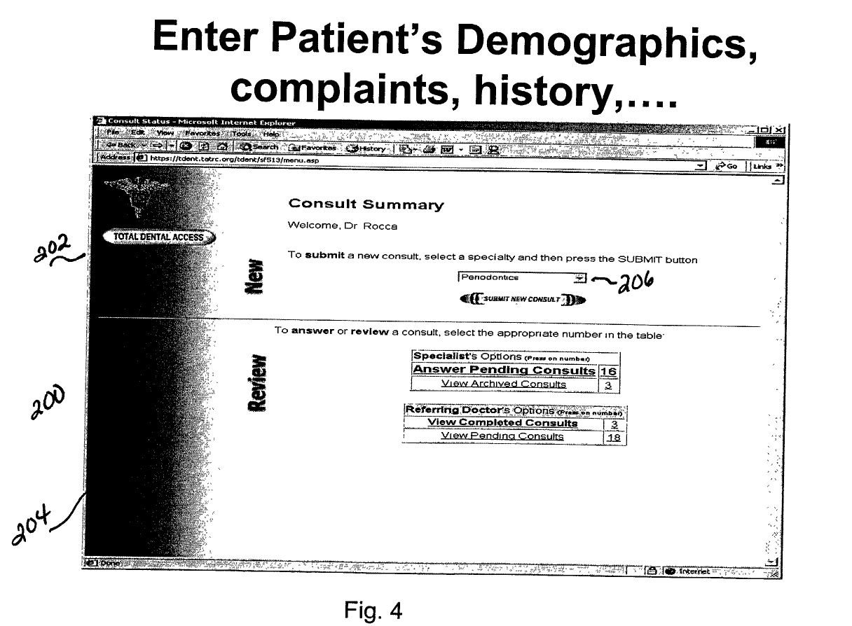

Referring now to FIGS. 4-7 exemplary user interfaces that assist the user in creating the dental consult record, according to one embodiment of the present invention, are depicted. Upon logging in to the system, the user is initially presented with a user interface 200 comprising a plurality of prompts as shown in FIG. 4. As used herein, the term prompt refers to any user interface element that allows input or selection of data. Exemplary prompts include dialog boxes, radio buttons, pull down menus, links, interactive graphical representations, etc. displaying a number of user options each in the form of links. The user options are separated into two primary fields, the first field 202 for submission of new consults and the second field 204 for answering or reviewing consults.

When creating a new consult request, the user may select a dental specialty from dialog box 206. Typically a user who selects this option is the referring provider. Dialog box 206 includes a drop down menu so that the user is presented with a list of dental specialties. Accordingly, the user can select the appropriate specialty to which the patient's condition pertains. Exemplary specialties include, but are not limited to, Comprehensive, Endodontics, Oral Medicine, Orthodontics, Pediatric Dentistry, Periodontics, Prosthodontics, TMD (Temporal Mandibular Disorder)/Orafacial Pain.

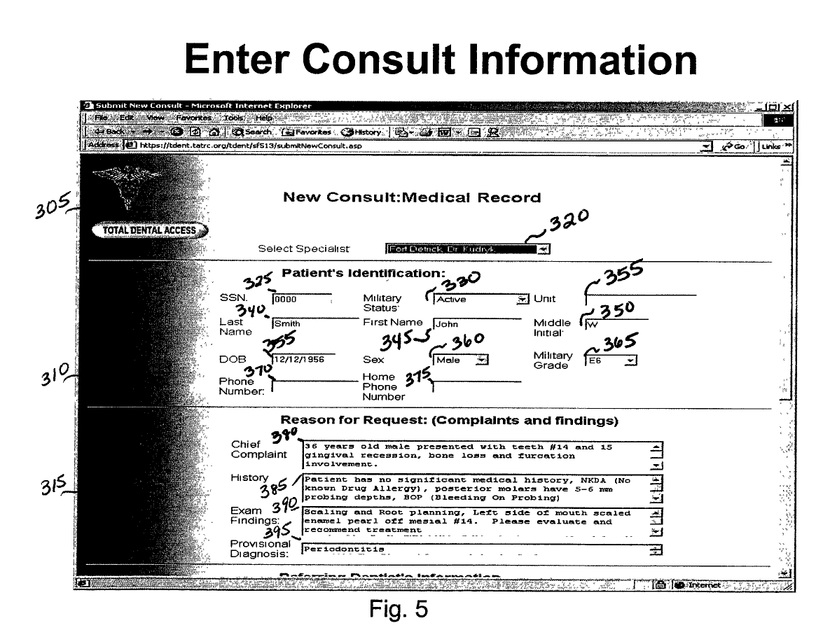

Upon selection of a dental specialty, user interface 300 is presented as illustrated in FIG. 5. User interface 300 is preferably provided with a “Medical Record” field 305, a Patient's Identification field 310 and a Reasons for Request field 315. Medical Record field 305 includes a dialog box 320 that includes a pull down menu to provide the user a list of referring providers. The user should select the appropriate referring provider from the list.

Patient Identification field 310 is provided with a plurality of prompts intended to capture information about the patient. The type of information captured in Patient Identification field 310 may vary depending upon the environment in which the system is used and the record keeping objectives of the system administrators. The illustrated embodiment is designed for use in a military health care system. However, the system may be readily adapted for use in a civilian health care system.

Patient Identification field 310 includes dialog box 325 intended for input of the patient's social security number; dialog box 330 including a pull down menu for identifying the patient's military status; dialog box 335 intended for input of the patient's unit; dialog boxes 340, 345 and 350 intended for input of the patient's last name, first name and middle initial, respectively; dialog box 355 for input of the patient's date of birth; dialog box 360 including a pull down menu for selection of the patient's sex; dialog box 365 including a pull down menu for selection of the patient's military grade; dialog boxes 370 and 375 for input of the patient's phone numbers.

Reasons for Request field 315 is provided with a plurality of prompts intended to capture information relating to the patient's condition. For example, Reasons for Request field 315 includes dialog box 380 intended for input of the patient's primary complaint; dialog box 385 intended for input of the patient's medical history, preferably as it relates to the patient's complaint; dialog box 390 intended for input of the referring provider's patient examination notes and findings; dialog box 395 intended for input of the referring provider's preliminary diagnosis.

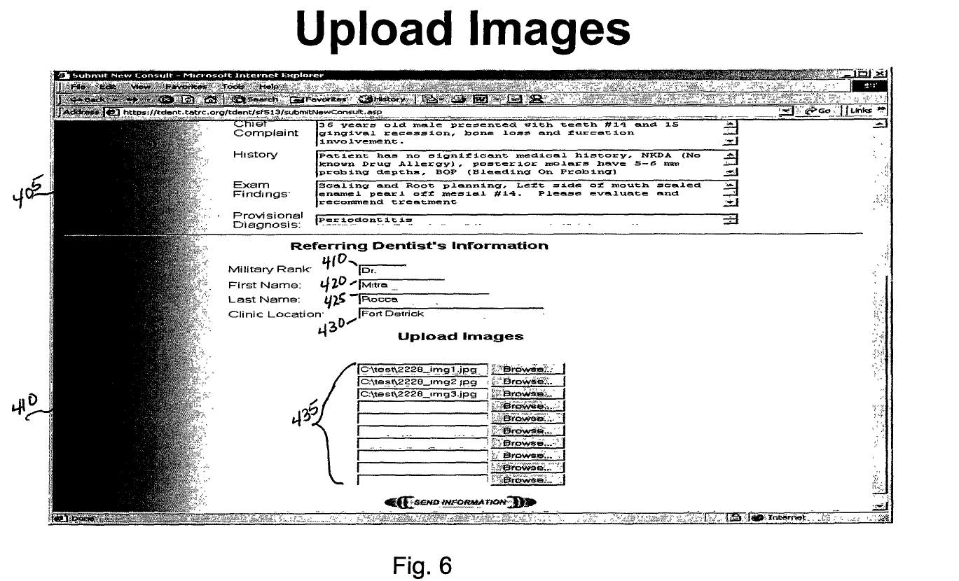

As illustrated in FIG. 6, user interface 400 is provided with a number of prompts intended to capture information about the referring provider. The type of information captured by interface 400 may vary depending upon the environment in which the system is used and the record keeping objectives of the system administrator. User interface 400 includes Referring Dentist Information field 405 having a dialog box 415 intended for input of the military rank of the referring provider; dialog boxes 420 and 425 intended for input of the first and last name of the referring provider, respectively; and dialog box 430 intended for input of the clinic location at which the referring provider is located.

FIG. 6. also includes an upload image field 410. This field includes a plurality of dialog boxes 435 including menus facilitating selection of a patient image or digital radiograph stored on the referring provider's workstation.

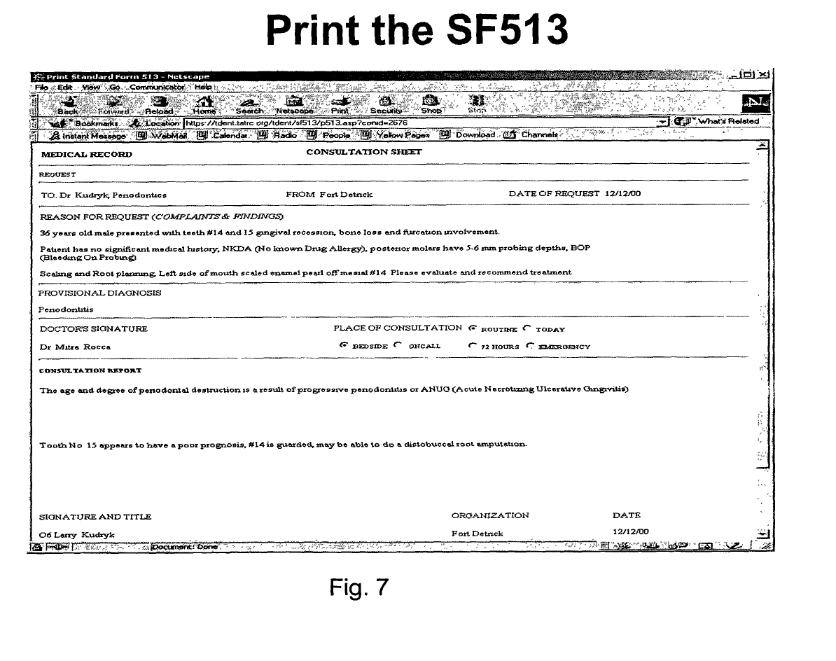

In accordance with a preferred embodiment of the invention, after uploading the desired images, the request for consult is preferably transmitted to the web server and the consulting provider is preferably notified, e.g., via email, that there is a pending request for consult. The request for consult may be printed in any desired form. As illustrated in FIG. 7, in one embodiment of the invention, the request for consult is printed on a standard military consultation form (SF513). However, the request for consult may be formatted according to the needs of the user.

Responding to a Request for Consult

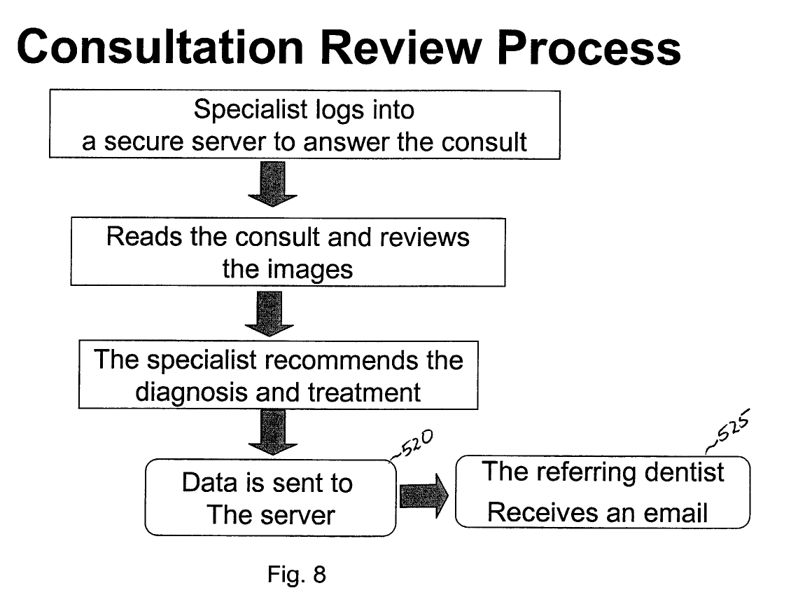

FIG. 8 illustrates a flow chart for an exemplary method of responding to a consult request according to the present invention. A consulting provider is prompted to log into a secure server using a digital secure server ID, e.g., web server 12, preferably via the consulting provider workstation 18. Step 500. Upon logging in, the consulting provider is prompted to select and review a pending request for consult template. Step 510. In step 515 the referring provider may be prompted to input diagnosis and/or treatment data to the request for consult template. Responsive to a command by the consulting provider, the consulting provider workstation then sends the data to the web server 12. Step 520. Optionally, a message may be sent to the referring provider, e.g., an email, informing the referring provider that the pending request for consult has been answered. Step 525.

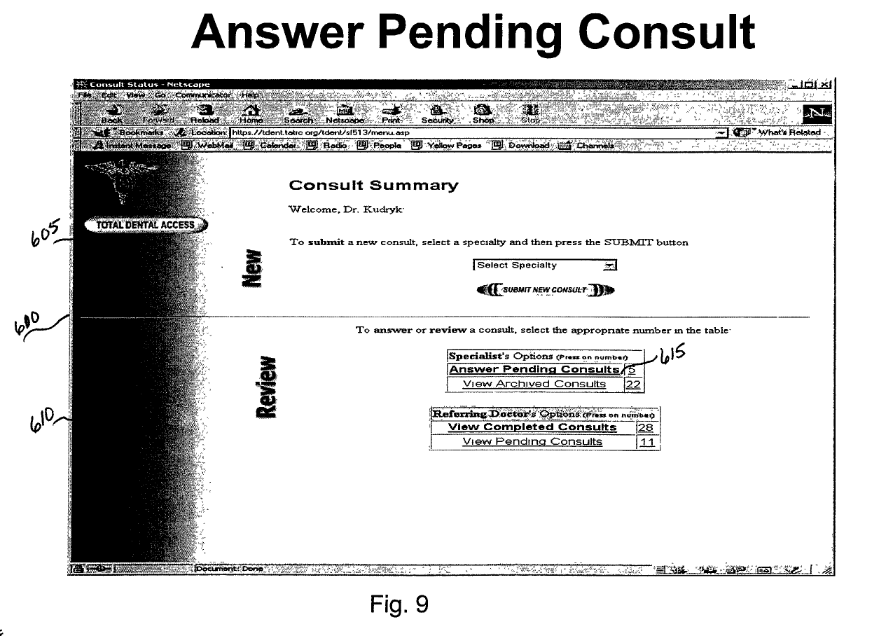

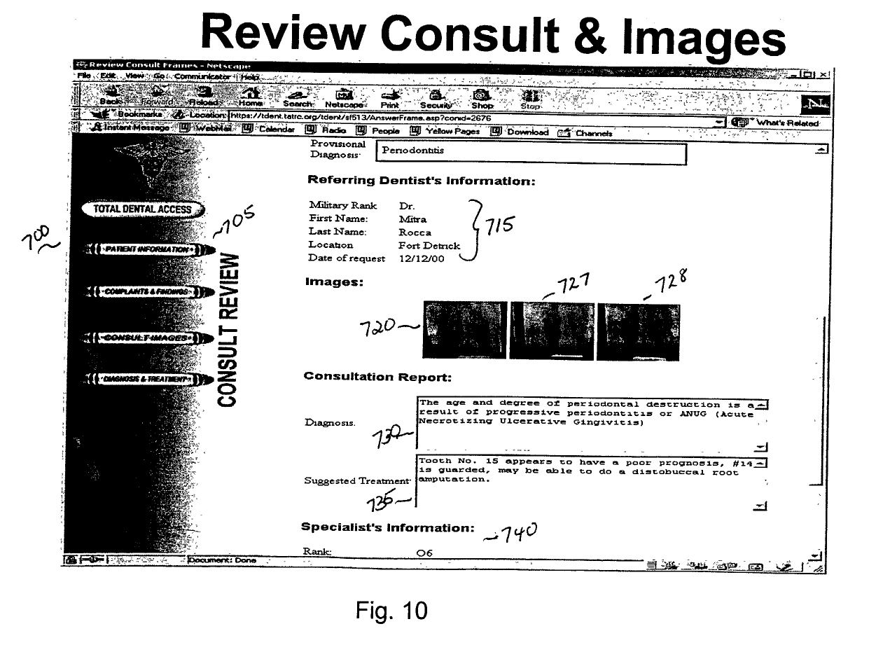

Referring now to FIGS. 9 and 10 exemplary user interfaces that assist the consulting provider in responding to the request for consult, according to one embodiment of the present invention, are depicted. Upon logging into the system, the consulting provider is initially provided with a user interface 600 comprising a plurality of prompts as illustrated in FIG. 9. The prompts are separated into two primary fields, the first field 605 for submission of new consults and the second filed 610 for answering or reviewing consults.

When answering a request for consult, the consulting provider may select a request for consult by activating a link 615. Upon activation of link 615, the consulting provider may be presented with a user interface 700 (FIG. 10) comprising the data from the selected request for consult. User interface 700 is preferably provided with a Patient Information Field 705, a Complaints and Findings field 710, Referring Provider's Information field 715, image field 720, diagnosis and treatment field 725 and Consulting Provider's Information field 740.

Patient Information field 705 preferably includes data contained in Patient Identification field 310 of the consult request (FIG. 5). Complaints and Findings field 710 preferably includes data contained in the Reasons for Request field 315 of the consult request (FIG. 5). Referring Provider Information field preferably includes identifying data for the referring provider including first and last name, location, date of request and military rank. The foregoing is exemplary of identifying data and depending upon the environment in which the invention is employed, other identifying data may be provided instead of or in addition to the foregoing.

Image field 720 is also provided to allow the consulting provider to view the patient's condition. Image field 720 may comprise one or more images 726, 727 and 728, i.e. digital images or radiographs, showing different angles and views of the patient's dental condition.

In keeping with a preferred aspect of the invention, an image manipulation routine is provided that allows the consulting provider to manipulate the image in a variety of ways. User Interface 700 is commonly viewed through a traditional web browser. Typically, embedded images are rendered at their actual size and shown at their original contrast and brightness by web browsers. In preferred embodiments, the images are created by a digital camera and sometimes need to be rearranged, e.g., rotated. The image manipulation routine allows the consulting provider to perform one or more of the following: 1) zoom in and out on an image, 2) invert the image, 3) rotate the image, 4) flip the image, and 5) change the contrast and brightness of the image.

Diagnosis and Treatment field 725 includes a plurality of dialog boxes 730 and 735 intended to capture the consulting provider's diagnosis and recommended treatment of the patient, respectively. More particularly, dialog box 730 is a prompt for input of the consulting provider's diagnosis of the patient and dialog box 735 is a prompt for the consulting provider's input of the recommended treatment of the patient.

Consulting Provider's Information field 740 preferably includes identifying data for the consulting provider including first and last name, location, date of consult response and military rank. The foregoing is exemplary of identifying data that may be included in the Consulting Provider's Information field 740 and, depending upon the environment in which the invention is employed, other identifying data may be provided instead of or in addition to the foregoing.

After inputting the diagnosis and treatment data, the modified consult record is preferably stored. The data from the consult may be stored according in a series of relational databases either at a remote user computer 20 (one of the referring provider and the consulting provider workstations) or the host computer 22.

Industrial Applicability

The present invention is useful in a number of different situations illustrated by the following examples.

1. A patient who has undergone oral surgery requires a one-week post surgical suture removal and examination. The patient returns to the general dentist's clinic and is examined electronically by the specialist. The specialist makes the recommendations and determines the disposition of the patient. The general dentist then accomplishes the necessary treatment.

2. A dentist using the present invention can document and submit claims to a dental insurance company for justification and documentation of a patient's condition prior to treating the patient.

3. A board certified specialist equipped with the present invention at a major medical center is sent a consultation and associated images of a specific dental problem. The specialist examines the images and recommends treatment options for the patient to the referring dentist.

4. A dentist is preparing to perform a major oral reconstruction of a patient. Prior to preparing the teeth the dentist contacts a dental laboratory, sending images of the teeth and dental casts for evaluation. The dental laboratory is able to make custom temporaries as well as obtain esthetic views and specific coloration of the teeth prior to making the permanent restorations.

5. In a dental under served area of the country, a patient in a general dentist's office is able to have its teeth, radiographs, and dental casts imaged and recorded online with the present invention. This information then can be transmitted to a specialist in a large city or dental center for evaluation and treatment planning, thus saving the patient travel from one site to another.

While the invention has been disclosed with reference to a limited number of embodiments, it is apparent that variations and modification may be made therein, and it is therefore intended in the following claims to cover each such variation and modification as falls within the true spirit and scope of the invention.

What is claimed is:

1. A method in a computer system for generating a dental consult record comprising:
prompting a referring provider to input dental specialty data to a template;
prompting the referring provider to input patient identification data to the template;
prompting the referring provider to input patient examination results to the template;
prompting the referring provider to input patient history to the template;
linking one or more images to the template; and
storing the template in a storage location.

2. The method of claim 1 wherein prompting a referring provider to input dental specialty data to a template includes generating a dental specialty dialog box.

3. The method of claim 2 wherein the dental specialty dialog box includes a drop down menu.

4. The method of claim I wherein prompting the referring provider to input patient examination results to the template includes generating a dedicated dialog box for examination results.

5. The method of claim 1 wherein prompting the referring provider to input patient history includes generating dedicated dialog box for patient history information.

6. The method of claim 1 further comprising prompting the referring provider to input a provisional diagnosis to the template.

7. The method of claim 6 wherein prompting the referring provider to input a provisional diagnosis to the template includes generating a dedicated dialog box for the provisional diagnosis.

8. The method of claim 1 further comprising transmitting a message to the referring provider responsive to storing the template in the storage location.

9. The method of claim 1 further comprising prompting a consulting provider to review a dental consult record comprising a template, prompting the consulting provider to input diagnosis and treatment data to the template; and storing the template in a storage location.

10. A data signal embodied in a carrier wave readable by a computing system and encoding instructions for executing the method recited in claim 9.

11. A data signal embodied in a carrier wave readable by a computing system and encoding instructions for executing the method recited in claim 1.

12. An article of manufacture comprising a computer usable medium having computer readable program code embodied therein for performing the method of claim 1.

13. A method in a computer system for generating a dental consult response comprising:
prompting a consulting provider to review a dental consult record comprising a template;
prompting the consulting provider to input diagnosis and treatment data to the template; and
storing the template in a storage location.

14. The method according to claim 13 wherein prompting the consulting provider to input diagnosis and treatment data includes generating a dialog box for diagnosis and treatment data.

15. A data signal embodied in a carrier wave readable by a computing system and encoding instructions for executing the method recited in claim 13.

16. The method of claim wherein the dental consult record includes a plurality of images and wherein prompting the consulting provider to review the dental consult record includes prompting the consulting provider to view the plurality of images.

17. An article of manufacture comprising a computer usable medium having computer readable program code embodied therein for performing the method of claim 13.

18. An article of manufacture comprising a computer usable medium having computer readable program code embodied therein for causing a computer to generate a patient's dental consult record, the computer readable program code comprising:
program code for prompting a referring provider to input dental specialty data to a template;
program code for prompting the referring provider to input patient identification data to the template;
program code for prompting the referring provider to input patient examination results to the template;
program code for, prompting the referring provider to input patient history to the template;
program code for linking one or more images to the template; and
program code for storing the template in a first storage location.

19. The article of manufacture of claim 18 further comprising:
program code for prompting a consulting provider to review a dental consult record comprising the template stored in the first storage location;
program code for prompting the consulting provider to input diagnosis and treatment data to the template; and
storing the template in a second storage location.

20. The article of manufacture of claim 18 further comprising program code for manipulating the linked image.

21. The article of manufacture of claim 20 further including program code for rotating the linked image.

22. The article of manufacture of claim 20 further including program code for inverting the linked image.

23. The article of manufacture of claim 20 further including program code for changing the field of view of the linked image.

24. The article of manufacture of claim 20 including program code for changing at least one of the contrast and brightness of the linked image.
